(19) United States
(12) Patent Application Publication
(10) Pub. No.: US 2026/0299269 A1
(43) Pub. Date: Oct. 1, 2026

(54) OPTICAL SYSTEM AND DISPLAY APPARATUS

(71) Applicant: CANON KABUSHIKI KAISHA, Tokyo (JP)

(72) Inventor: Yoshihisa TASHIRO, Tochigi (JP)

(21) Appl. No.: 19/571,754

(22) Filed: Mar. 19, 2026

(30) Foreign Application Priority Data
Mar. 31, 2025 (JP) 2025-057713

(51) Int. Cl. G02B 17/08

(52) U.S. Cl. CPC G02B 17/086

(57) ABSTRACT

An optical system may guide image light from a display element toward an observation side, and may include a cemented lens including at least three lenses cemented together that include a negative lens, and a first transmissive reflective surface and a second transmissive reflective surface, each having a concave shape on the observation side in a paraxial region. At least one of the first transmissive reflective surface and the second transmissive reflective surface may be disposed on a cemented surface of the cemented lens. Predetermined inequalities are satisfied.

### BACKGROUND

### Field of the Technology

The present disclosure relates to an optical system, for example, for a display apparatus, such as a head-mounted display (HMD) and smart glasses.

### Description of the Related Art

As an optical system of the type described above, PCT Application Domestic Publication No. 2019-526075 discloses an optical system having two transmissive reflective surfaces and a cemented lens formed by cementing three lenses.

### SUMMARY

An optical system according to one aspect of the present disclosure may guide image light from a display element toward an observation side, and may include a cemented lens including at least three lenses cemented together that include a negative lens, and a first transmissive reflective surface and a second transmissive reflective surface, each having a concave shape on the observation side in a paraxial region. At least one of the first transmissive reflective surface and the second transmissive reflective surface may be disposed on a cemented surface of the cemented lens. The image light may be guided toward the observation side via transmission through the second transmissive reflective surface, reflection on the first transmissive reflective surface, reflection on the second transmissive reflective surface, and transmission through the first transmissive reflective surface. The following inequalities may be satisfied:

$$10. 0 \leq vdGn \leq 50.$$

$$- 10. 0 \leq fGn / f \leq - 1.$$

$$0. < R\_HM2 / R\_HM1 \leq 1.$$

where vdGn is an Abbe number of the negative lens based on d-line, fGn is a focal length of the negative lens in air, f is a focal length of the optical system, R_HM1 is a paraxial radius of curvature of the first transmissive reflective surface, and R_HM2 is a paraxial radius of curvature of the second transmissive reflective surface. Alternatively, the image light may be guided toward the observation side via transmission through the second transmissive reflective surface, reflection on the first transmissive reflective surface, reflection on the second transmissive reflective surface, and transmission through the first transmissive reflective surface.

Features of the present disclosure will become apparent from the following description of embodiments with reference to the attached drawings. The following description of embodiments is described by way of example.

### BRIEF DESCRIPTION OF THE DRAWINGS

FIG. 1 is a sectional view of an optical system according to Example 1.

FIG. 2 is a longitudinal aberration diagram of the optical system according to Example 1.

FIG. 3 is a sectional view of an optical system according to Example 2.

FIG. 4 is a longitudinal aberration diagram of the optical system according to Example 2.

FIG. 5 is a sectional view of an optical system according to Example 3.

FIG. 6 is a longitudinal aberration diagram of the optical system according to Example 3.

FIG. 7 is a sectional view of an optical system according to Example 4.

FIG. 8 is a longitudinal aberration diagram of the optical system according to Example 4.

FIG. 9 is a sectional view of an optical system according to Example 5.

FIG. 10 is a longitudinal aberration diagram of the optical system according to Example 5.

FIG. 11 is a sectional view of an optical system according to Example 6.

FIG. 12 is a longitudinal aberration diagram of the optical system according to Example 6.

FIG. 13 illustrates polarization utilization configuration 1.

FIG. 14 illustrates polarization utilization configuration 2.

FIG. 15 illustrates an HMD using any one of the optical systems according to Examples 1 to 6.

### DESCRIPTION OF THE EMBODIMENTS

A description will now be given of examples of the present disclosure with reference to the drawings.

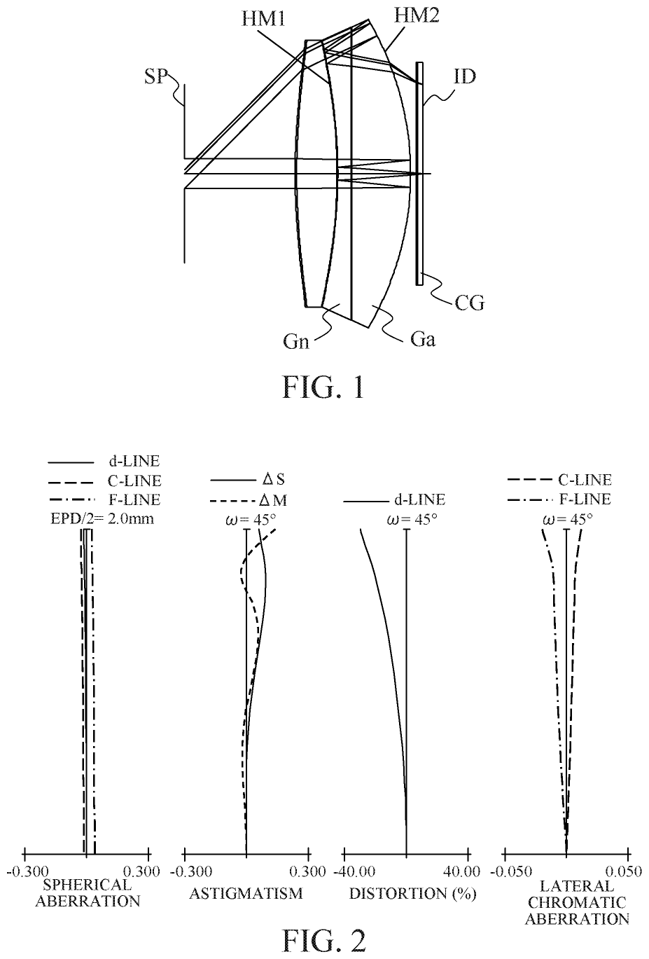

FIGS. 1, 3, 5, 7, 9, and 11 illustrate the configurations of the optical systems according to Examples 1 to 6, respectively. Each optical system according to the examples is an optical system that guides image light from a display element (display surface ID) to an observation side (an exit pupil side or an observer's eye). More specifically, the optical system enlarges an image displayed on the display element and presents the enlarged image to the observer in a display apparatus such as an HMD or smart glasses.

In such an optical system, in a case where an electronic device such as an LCD is used as the display element, lateral chromatic aberration of the optical system can be electronically corrected by adjusting the magnification of an image displayed for each of RGB color channels at the display element. However, chromatic aberration occurring within each RGB color channel cannot be electronically corrected. Thus, when a high-definition display element having a small pixel pitch is used as the display element, there is a risk that image quality of the displayed image deteriorates due to chromatic aberration of the optical system.

PCT Application Domestic Publication No. 2019-526075 discloses, in FIG. 6, an example in which a plano-concave lens is disposed in an optical system. In this configuration, the role of the plano-concave lens is to minimize stress applied to a quarter waveplate by placing the quarter waveplate on a planar surface of the lens. PCT Application Domestic Publication No. 2019-526075 discloses configurations, as disclosed in FIGS. 7 to 9, in which stress is minimized by placing a quarter waveplate on a cylindrical surface. In such configurations, in order to correct chromatic aberration of the optical system, a lens on an observation side of a surface on which the quarter waveplate is disposed and a lens on a display element side may be formed of optical materials having different refractive indices and Abbe numbers. In this case, in a case where different materials are used for the lens on the observation side and the lens on the display element side of the cylindrical surface, asymmetric aberrations are generated due to the refractive action of the cylindrical surface. On the other hand, in a case where the same material is used for the lens on the observation side and the lens on the display element side of the cylindrical surface, chromatic aberration cannot be corrected.

Accordingly, each optical system according to the examples includes a cemented lens formed by cementing at least three lenses including a negative lens Gn. Using such a cemented lens can satisfactorily correct chromatic aberration of the entire optical system, and minimize the number of lens surfaces in contact with air among lens surfaces of the three lenses, thereby reducing unnecessary light (ghosts) generated by reflection at the lens surfaces. Using the negative lens Gn can satisfactorily correct chromatic aberration of the entire optical system. The number of lenses constituting the cemented lens may be four or more.

The optical system according to each example further includes a first transmissive reflective surface (referred to as HM1 hereinafter) and a second transmissive reflective surface (referred to as HM2 hereinafter), each having a concave shape toward the observation side in a paraxial region. HM2 and HM1 are arranged in this order from the display element side or from the observation side. The phrase “having a concave shape toward the observation side in the paraxial region” means that an r term of an aspherical shape expression in numerical examples described later is negative. More specifically, this means that a reference spherical surface at a height near the optical axis, for example, about one-tenth of an effective diameter, is concave toward the observation side. More specifically, this means that a reference spherical surface at a height of about 2 mm, which is half of a typical pupil diameter ΦD4 mm of an observer, is concave toward the observation side. The effective diameter is a diameter of a region of an optical surface through which light rays contributing to image display pass. The reference spherical surface is a spherical surface determined by coordinates of a surface vertex on the optical axis and a surface at a height of about one-tenth of the effective diameter. By using such HM1 and HM2, each lens surface becomes concentric with respect to the observer's pupil, thereby allowing curvature of field and astigmatism to be well corrected in a wide-angle optical system.

The display element is not limited to a panel-type electronic device that displays a two-dimensional image, such as an LCD, and may include a configuration having a light source that emits laser light or LED light and a scanning device that two-dimensionally scans light from the light source.

In the optical system according to each example, at least one of HM1 and HM2 is disposed on a cemented surface of the cemented lens. Thereby, the transmissive reflective surface disposed on the cemented surface can be prevented from being directly exposed to an external environment. Thus, in a case where a half-mirror formed of a metal or a dielectric multilayer film or a film-shaped element is used as the transmissive reflective surface, the film or the multilayer can be stably disposed in the optical system against changes in external environments such as temperature and humidity.

The optical system according to each example using HM1 and HM2 forms a triple-pass optical path that guides image light from the display element to the observation side via transmission at HM2, reflection at HM1, reflection at HM2, and transmission at HM1. By adopting such a triple-pass in which image light travels three times between HM1 and HM2 and folding the optical path, the thickness of the optical system can be reduced.

Here, let vdGn be an Abbe number of the optical material of the negative lens Gn based on the d-line. The definition of the Abbe number based on the d-line will be described later. Let fGn be a focal length of the negative lens Gn with respect to refraction in air. The focal length of the negative lens Gn with respect to refraction herein does not include a focal length with respect to reflection when a transmissive reflective surface is disposed on a lens surface of the negative lens Gn. Let f be a focal length of the entire optical system, let R_HM1 be a paraxial radius of curvature of HM1, and let R_HM2 be a paraxial radius of curvature of HM2. In this case, the optical system according to each example may satisfy at least one of the following inequalities (1), (2), and (3):

$$10. \leq vdGn \leq 50. \qquad ( 1 )$$

$$- 10. 0 \leq f G n / f \leq - 1. \qquad ( 2 )$$

$$0. < R\_HM2 / R\_HM1 \leq 1. \qquad ( 3 )$$

Inequality (1) defines a proper range of the Abbe number of the negative lens Gn. Using an optical material having a proper Abbe number for the negative lens Gn can correct monochromatic aberration and chromatic aberration. In a case where vdGn is smaller than the lower limit of inequality (1), the Abbe number of the negative lens Gn becomes too small, resulting in overcorrection of chromatic aberration. In addition, a light absorption amount of the optical material of the negative lens Gn in a visible light region increases, thereby reducing transmittance of the entire optical system. In a case where vdGn becomes higher than the upper limit of inequality (1), the Abbe number of the negative lens Gn becomes too large, resulting in insufficient correction of chromatic aberration, and it becomes difficult to achieve both monochromatic aberration correction and chromatic aberration correction.

The lower limit of inequality (1) may be 12.0, 15.0, 18.0, or 20.0. The upper limit of inequality (1) may be 45.0, 40.0, 35.0, or 30.0.

Inequality (2) defines a proper relationship between the focal length of the negative lens Gn and the focal length of the entire optical system. In a case where fGn/f satisfies inequality (2), refractive power of the negative lens Gn in the optical system can be optimized, thereby achieving both chromatic aberration correction and the size reduction of the optical system. In a case where fGn/f becomes lower than the lower limit of inequality (2), negative refractive power of the negative lens Gn becomes too large relative to the focal length of the entire system, resulting in overcorrection of chromatic aberration in the entire optical system. Alternatively, the focal length of the entire optical system becomes too large, resulting in an increase in size of the optical system. In a case where fGn/f becomes higher than the upper limit of inequality (2), negative refractive power of the negative lens Gn becomes too small relative to the focal length of the entire system, resulting in insufficient correction of chromatic aberration in the entire optical system.

Alternatively, the focal length of the entire optical system becomes too small, and it becomes difficult to correct monochromatic aberrations such as curvature of field in the entire optical system.

The lower limit of inequality (2) may be −8.0, −6.0, −5.0, or −3.0. The upper limit of inequality (2) may be −1.5, −2.0, −2.5, or −4.0.

Inequality (3) defines a proper relationship between the paraxial radii of curvature of HM1 and HM2. In the optical system according to each example, HM1 has negative optical power (reciprocal of focal length) with respect to reflection, and HM2 has positive optical power with respect to reflection. Optimizing the arrangement of the transmissive reflective surfaces can achieve a wide angle of field (high optical magnification) and correction of curvature of field and astigmatism. In a case where R_HM2/R_HM1 is lower than the lower limit of inequality (3), the radius of curvature of HM1 becomes too large relative to the radius of curvature of HM2. As a result, negative optical power shared by HM1 through reflection becomes too weak, making correction of curvature of field difficult. In a case where R_HM2/R_HM1 becomes higher than the upper limit of inequality (3), the radius of curvature of HM1 becomes too small relative to the radius of curvature of HM2. As a result, negative optical power shared by HM1 through reflection becomes too strong, and it becomes difficult to achieve a wide angle of field of the optical system. Alternatively, in order to maintain an angle of field (magnification) of the optical system, the radius of curvature of HM2 may be further reduced, and aberration sensitivity of HM2 becomes excessively high.

The lower limit of inequality (3) may be 0.2, 0.4, or 0.5. The upper limit of inequality (3) may be 0.95, 0.9, or 0.8.

Each optical system according to the examples may satisfy at least one of configurations A to F and inequalities (4) and (5) described below.

### Configuration A

In each example, the negative lens Gn may be disposed between HM1 and HM2. This configuration places the negative lens Gn in a triple-pass region. In this case, the negative lens Gn shares negative refractive power (the reciprocal of focal length) three times, thereby allowing chromatic aberration of the entire optical system to be well corrected.

### Configuration B

In each example, the negative lens Gn may have a plano-concave shape. By forming one surface of the negative lens Gn as a planar surface, when a polarization utilization configuration described later is adopted, a quarter waveplate can be disposed on the planar surface, thereby reducing stress applied to the quarter waveplate.

### Configuration C

In each example, the negative lens Gn may be disposed closer to the display element side than HM2. This configuration places the negative lens Gn in a single-pass region through which image light passes only once. In the polarization utilization configuration described later, leakage light is generated due to birefringence of lenses in an optical path of polarized light. The negative lens Gn, which is formed of a resin lens material satisfying inequality (1) and disposed in the single-pass region, can reduce the influence of lens birefringence.

### Configuration D

In each example, HM11 may be disposed on a cemented surface of the cemented lens described above. HM1 disposed on the observation side of the optical system may be positioned at a location that can be directly touched by an observer. Placing HM1 on the cemented surface of the cemented lens can avoid direct contact of the observer with HM1. In addition, HM1 can be stably disposed against changes in an external environment.

### Configuration E

In each example, a lens Ga serving as an intermediate lens may be disposed between HM1 and HM2. The following inequality (4) may be satisfied:

$$40. \leq vdGa \leq 90. \qquad ( 4 )$$

where vdGa is an Abbe number of the lens Ga based on the d-line.

In this configuration, the lens Ga is disposed in the triple-pass region. In this case, by forming the lens Ga of a lens material satisfying inequality (4), chromatic aberration generated in the optical system can be reduced, the transmittance of the entire optical system is maintained, and a wide angle of field and aberration correction can be achieved.

In a case where vdGa becomes lower than the lower limit of inequality (4), the Abbe number of the lens Ga becomes too small, resulting in excessive chromatic aberration generated by refraction in the triple-pass region. Furthermore, in a case where the lens Ga is formed as a resin lens in order to reduce weight of the optical system, light absorption of the optical material in a visible light region increases, thereby reducing transmittance of the entire optical system. In a case where vdGa becomes higher than the upper limit of inequality (4), the Abbe number of the lens Ga becomes too large. As a result, although chromatic aberration generated by refraction is small, optical materials satisfying inequality (4) have excessively low refractive indices, and it becomes difficult to achieve a wide angle of field and aberration correction.

The lower limit of inequality (4) may be 45.0, 50.0, or 52.0. The upper limit of inequality (4) may be 80.0, 70.0, or 60.0.

### Configuration F

The following inequality (5) may be satisfied.

$$0 \leq f G a / f \leq 100.0 \qquad ( 5 )$$

where fGa is a focal length of the lens Ga with respect to refraction in air in configuration E.

Inequality (5) defines a proper refractive power when the lens Ga is disposed as a positive lens in the triple-pass region. Properly setting positive refractive power of the lens Ga can achieve a wide angle of field and chromatic aberration correction.

In a case where fGa/f is lower than the lower limit of inequality (5), positive refractive power of the lens Ga becomes too large, resulting in excessive chromatic aberration generated by refraction in the triple-pass region. In a case where fGa/f becomes higher than the upper limit of inequality (5), positive refractive power of the lens Ga becomes too small, resulting in insufficient refractive power generated in the triple-pass region. As a result, it becomes difficult to achieve a wide angle of field of the optical system.

The lower limit of inequality (5) may be 2.0, 3.0, 10.0, 15.0, or 18.0. The upper limit of inequality (5) may be 80.0, 60.0, 40.0, or 35.0.

As another configuration, at least one of HM1 and HM2 may be formed of a polarization-selective transmissive reflective element. Adopting a polarization utilization configuration described later can suppress unnecessary light such as ghosts (leakage light). Examples of the polarization-selective transmissive reflective element include a wire-grid element such as WGF manufactured by Asahi Kasei Corporation, a reflective linear polarizer such as IQP-E manufactured by 3M Company, and a circularly polarizing reflective element using cholesteric liquid crystal. In a case where a reflective linear polarizer is used, a quarter waveplate is disposed between HM1 and HM2.

As a method of placing each polarization element such as HM1 and HM2, various methods may be selected, including a method in which a film-shaped polarization element is cemented to a lens surface, and a method in which a wire-grid structure is integrally molded with a lens base material during molding of a resin lens.

A description will now be given of a polarization utilization configuration. This configuration can suppress unnecessary light that propagates toward the observation side without being reflected even once by a transmissive reflective surface and also suppress a reduction in light amount of image light traveling along a regular optical path in the optical system.

### Polarization Utilization Configuration 1

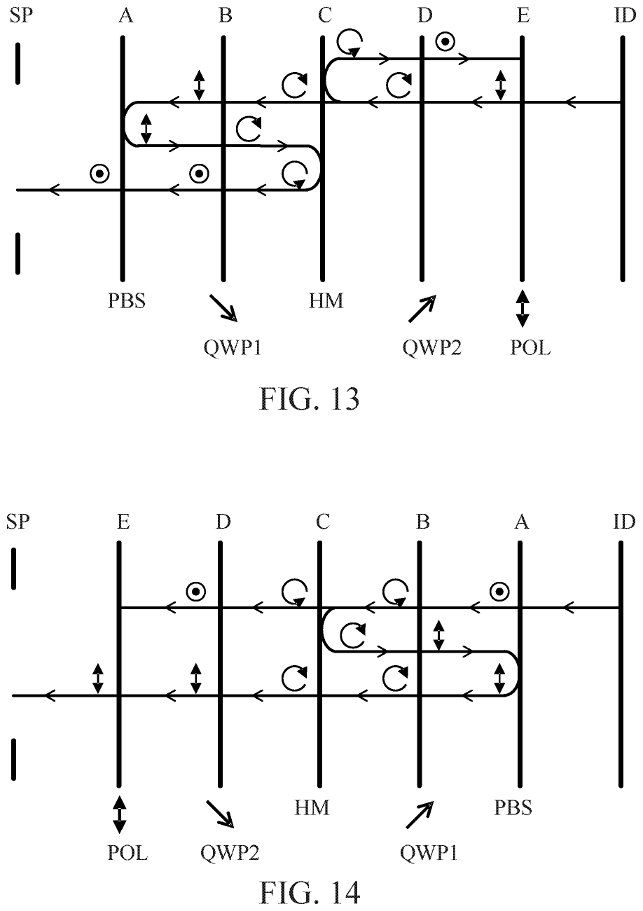

FIG. 13 illustrates polarization utilization configuration 1. This configuration includes a polarization-selective transmissive reflective element (PBS) A as HM1 disposed on an observation side (pupil plane SP side), and a half-mirror (HM) C as HM2 disposed on a display element side (display surface ID side). A first quarter waveplate (QWP1) B is disposed between the PBS and the HM. A second quarter waveplate (QWP2) D and a linear polarizer (POL) E are arranged in this order from the HM side between the HM and the ID.

The PBS is configured to reflect linearly polarized light having the same polarization direction as that of linearly polarized light transmitting through the POL, and to transmit linearly polarized light having a polarization direction orthogonal thereto. The PBS is, for example, a wire-grid polarizer or a reflective (reflection-type) polarizer having a retardation film laminated structure. In this case, a wire-grid forming surface or a retardation film surface of the PBS functions as a transmissive reflective surface.

The QWP1 and QWP2 are arranged such that their slow axes are tilted by 45° relative to a polarization transmission axis of the POL. The slow axes of the QWP1 and QWP2 may be arranged to be tilted by 90° relative to each other. According to this arrangement, the wavelength dispersion characteristics of the QWP1 and QWP2 cancel each other when light rays transmit through them.

The HM is, for example, a half-mirror formed by a dielectric multilayer film or metal deposition. A ratio of reflectance to transmittance of the half-mirror may be 50:50 from a viewpoint of transmittance of the entire optical system, but other ratios may be used. The POL is, for example, an absorption-type linear polarizer.

Image light as unpolarized light emitted from the ID becomes first linearly polarized light at the POL. The first linearly polarized light is converted into first circularly polarized light by the QWP2 and enters the HM. A part of the first circularly polarized light incident on the HM is reflected by the HM and becomes second circularly polarized light rotating in an opposite direction to that of the first circularly polarized light, and the second circularly polarized light returns to the QWP2. The second circularly polarized light returning to the QWP2 is converted into second linearly polarized light having a polarization direction orthogonal to that of the first linearly polarized light. The second linearly polarized light returns to the POL and is absorbed by the POL.

On the other hand, the first circularly polarized light that has transmitted through the HM is converted by the QWP1 into third linearly polarized light having the same polarization direction as that of the first linearly polarized light, and the third linearly polarized light enters the PBS. The third linearly polarized light incident on the PBS is reflected by polarization selectivity of the PBS.

The third linearly polarized light reflected by the PBS is converted by the QWP1 into third circularly polarized light rotating in the same direction as that of the first circularly polarized light. The third circularly polarized light enters the HM and is reflected to become fourth circularly polarized light rotating in an opposite direction to that of the third circularly polarized light. The fourth circularly polarized light enters the QWP1 and is converted into fourth linearly polarized light having a polarization direction orthogonal to that of the third linearly polarized light. The fourth linearly polarized light enters the PBS, transmits through it by polarization selectivity of the PBS, and is guided to the SP.

Through the optical actions described above, only light that transmits through the HM, is reflected by the PBS, is reflected by the HM, and transmits through the PBS is guided to the SP and enters an observer's eye (pupil) disposed at the SP.

### Polarization Utilization Configuration 2

FIG. 14 illustrates polarization utilization configuration 2. This configuration includes a polarization-selective transmissive reflective element (PBS) A as HM2 arranged on a display element side (display surface ID side), and a half-mirror (HM) C as HM1 disposed on an observation side (pupil plane SP side). A first quarter waveplate (QWP1) B is disposed between the PBS and the HM. A second quarter waveplate (QWP2) D and a linear polarizer (POL) E are arranged between the HM and the SP in this order from the HM side. Configurations of respective elements and proper orientations of optical axes are the same as those in polarization utilization configuration 1.

Unpolarized image light emitted from the ID enters the PBS. Among the unpolarized light incident on the PBS, first linearly polarized light having a polarization direction orthogonal to a transmission axis of the POL transmits through the PBS. The first linearly polarized light that has transmitted through the PBS is converted into first circularly polarized light by the QWP1, and the first circularly polarized light enters the HM. A part of the first circularly polarized light incident on the HM transmits through it, enters the QWP2, and is converted into second linearly polarized light having the same polarization direction as that of the first linearly polarized light. The second linearly polarized light enters the POL and is absorbed by the POL.

On the other hand, the first circularly polarized light is reflected by the HM and becomes second circularly polarized light rotating in an opposite direction to that of the first circularly polarized light. The second circularly polarized light returns to the QWP1. The second circularly polarized light returning to the QWP1 is converted by the QWP1 into third linearly polarized light having a polarization direction orthogonal to that of the first linearly polarized light. The third linearly polarized light returns to the PBS. The third linearly polarized light returning to the PBS is reflected by the PBS, returns to the QWP1 again, and is converted into third circularly polarized light rotating in the same direction as that of the first circularly polarized light. The third circularly polarized light enters the HM again, transmits through it, enters the QWP2, and is converted by the QWP2 into fourth linearly polarized light having a polarization direction parallel to the transmission axis of the POL. The fourth linearly polarized light transmits through the POL and is guided to the SP.

By the optical actions described above, only light that transmits through the PBS (HM2), is reflected by the HM (HM1), is reflected by the PBS, and then transmits through the HM is guided to the SP and enters the eye of the observer positioned at the SP.

In the two polarization utilization configurations described above, various polarization elements may be additionally arranged in order to reduce unnecessary reflected light components at the PBS and the display surface ID. For example, in FIG. 13, by placing an absorptive linear polarizer having a transmission axis aligned with the transmission axis of the PBS on the observation side of the PBS, reflection of external light at the PBS can be reduced. In FIG. 14, placing a phase plate between the PBS and the display surface ID can reduce unnecessary reflected light components at the display surface ID. As the phase plate, a quarter waveplate or the like having a transmission axis tilted by 45° relative to the transmission axes of the POL and the PBS may be used.

In each example, the optical material of each lens may be a resin material. The resin material as the optical material can contribute to the weight reduction compared with the case of using a glass material.

Each example can adjust diopter using various methods. For example, diopter can be adjusted by moving the entire optical system or the display element in the direction in which the optical axis of the optical system extends (the left-right direction in each drawing). In addition to a method of moving the optical system in the optical axis direction, diopter may be adjusted by providing an optical element whose refractive power is changed by mechanical or electrical action, such as a variable-shape lens or a liquid crystal lens using pressure or electrowetting.

The optical systems according to Examples 1 to 6 will now be described in detail. After Example 6, numerical examples 1 to 6 corresponding to Examples 1 to 6, respectively, will be illustrated.

### Example 1

The optical system according to Example 1 (numerical example 1) illustrated in FIG. 1 is an optical system having an overall angle of field of about 90°. The optical system according to Example 1 includes, in order from the pupil plane SP side to the display surface ID side, a first lens having positive refractive power and a biconvex shape, a second lens having negative refractive power and a plano-concave shape (negative lens Gn), and a third lens having positive refractive power and a plano-convex shape (lens Ga). The first, second, and third lenses are cemented together to form a cemented lens. HM1 is disposed on a cemented surface between the first lens and the second lens, and HM2 is disposed on a lens surface on the display surface side of the third lens. The negative lens Gn as the second lens is disposed between HM1 and HM2.

Image light from the display surface ID transmits through HM2, is reflected by HM1, is reflected by HM2, transmits through HM1, and is guided to the pupil plane SP.

This example uses the polarization utilization configuration 1, a reflective polarization film (PBS) is used as HM1, and a half-mirror (HM) is used as HM2. In addition, a quarter waveplate (QWP1) is disposed on the cemented surface between the second lens and the third lens. A quarter waveplate (QWP2) and a linear polarizer (POL) are bonded to a surface on the pupil plane SP side of a glass block (cover glass) CG covering the display surface ID. A linear polarizer is disposed on a lens surface on the pupil plane SP side of the first lens to reduce reflection of external light by the reflective polarization film.

Table 1 summarizes the values of inequalities (1) to (5) in numerical example 1. The optical system according to numerical example 1 satisfies all inequalities (1) to (5).

FIG. 2 illustrates longitudinal aberrations (spherical aberration, astigmatism, distortion, and lateral chromatic aberration) of the optical system according to numerical example 1 (diopter: −0.77 diopters). In the spherical aberration diagram, EPD represents a pupil diameter, a solid line represents a spherical aberration amount for the d-line, a long broken line represents a spherical aberration amount for the C-line, and an alternate long and short dash line represents a spherical aberration amount for the F-line. In the astigmatism diagram, a solid line ΔS represents an astigmatism amount on a sagittal image surface, and a broken line ΔM represents an astigmatism amount on a meridional image surface. The distortion diagram illustrates a distortion amount for the d-line. The chromatic aberration diagram illustrates lateral chromatic aberration amounts for the C-line (long broken line) and the F-line (alternate long and short dash line). ω represents a half angle of field (°). A description of these longitudinal aberration diagrams is the same for the other numerical examples.

### Example 2

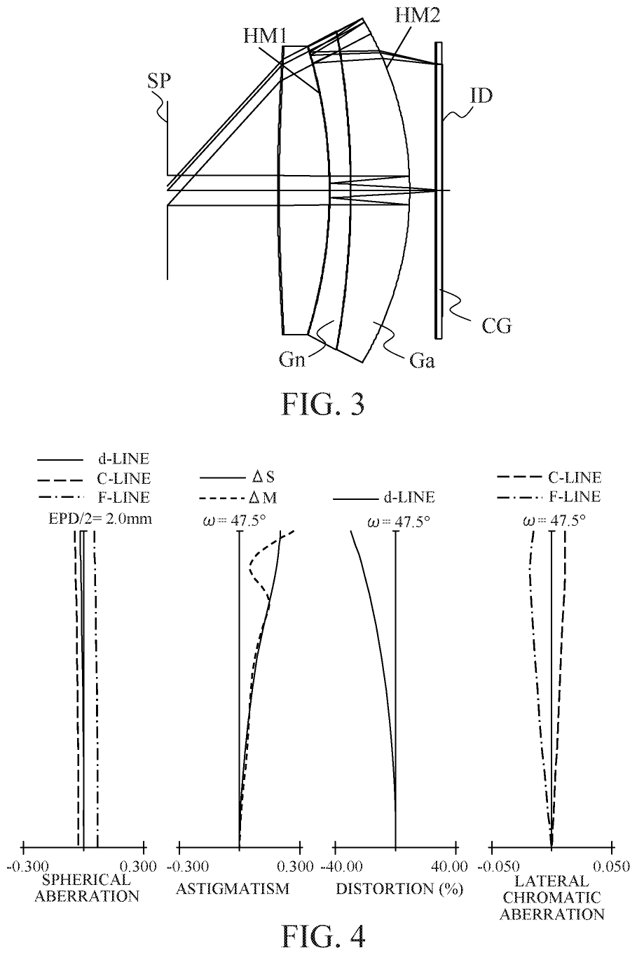

The optical system according to Example 2 (numerical example 2) illustrated in FIG. 3 is an optical system having an overall angle of field of about 95°. The basic configuration of the optical system according to Example 2 is the same as that according to Example 1. However, compared with Example 1, the display element is increased in size, and the second lens (negative lens Gn) is changed from a plano-concave shape to a meniscus shape having a convex surface facing the display surface side.

The polarization utilization configuration and the optical path of image light guided from the display surface ID to the pupil plane SP are the same as those according to Example 1.

Table 1 summarizes the values of inequalities (1) to (5) in numerical example 2. The optical system according to numerical example 2 satisfies all inequalities (1) to (5).

FIG. 4 illustrates longitudinal aberrations of the optical system according to numerical example 2.

### Example 3

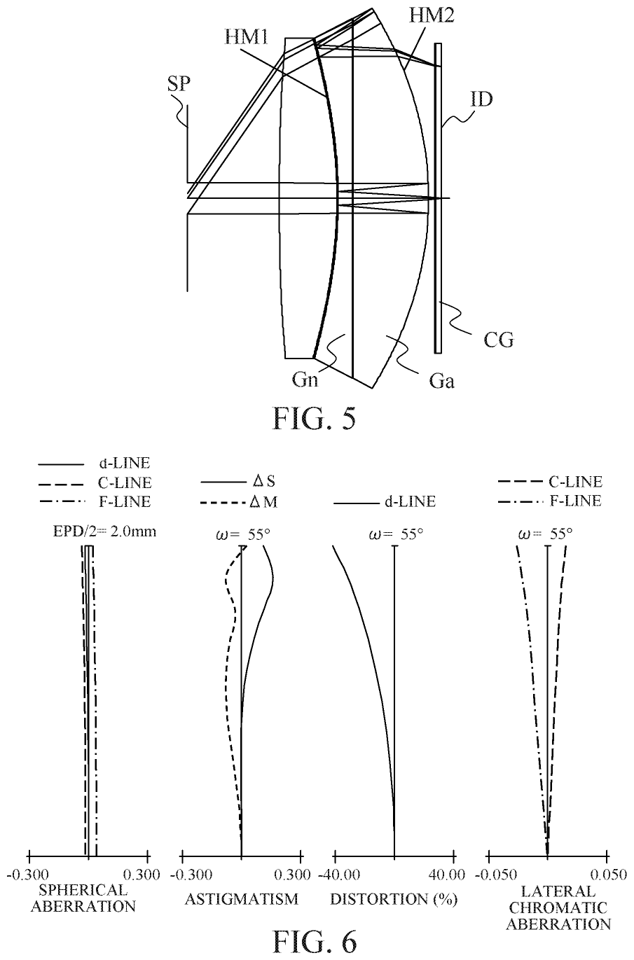

The optical system according to Example 3 (numerical example 3) illustrated in FIG. 5 is an optical system having an overall angle of field of about 110°. The basic configuration of the optical system according to Example 3 is the same as that according to Example 1. However, compared with Example 1, the display element is increased in size.

The polarization utilization configuration and the optical path of image light guided from the display surface ID to the pupil plane SP are the same as those according to Example 1. However, in this example, the linear polarizer disposed on a lens surface on the observation side of the first lens in Example 1 is laminated with the reflective polarization film (PBS) and disposed on the cemented surface between the first lens and the second lens.

Table 1 summarizes the values of inequalities (1) to (5) in numerical example 3. The optical system according to numerical example 3 satisfies all inequalities (1) to (5).

FIG. 6 illustrates longitudinal aberrations of the optical system according to numerical example 3.

### Example 4

The optical system according to Example 4 (numerical example 4) illustrated in FIG. 7 is an optical system having an overall angle of field of about 95°. The optical system according to Example 4 includes, in order from the pupil plane SP side to the display surface ID side, a first lens having positive refractive power and a plano-convex shape, a second lens having positive refractive power and a meniscus shape convex toward the display surface side (lens Ga), and a third lens having negative refractive power and a biconcave shape in a paraxial region (negative lens Gn). The first, second, and third lenses are cemented together to form a cemented lens.

HM1 is disposed on a cemented surface between the first lens and the second lens, and HM2 is disposed on a cemented surface between the second lens and the third lens. The negative lens Gn is disposed on the display surface ID side of HM2.

Image light from the display surface ID transmits through HM2, is reflected by HM1, is reflected by HM2, transmits through HM1, and is guided to the pupil plane SP.

This example also employs polarization utilization configuration 1. More specifically, a reflective polarization film (PBS) is used as HM1 and is disposed on the cemented surface between the first lens and the second lens together with a quarter waveplate (QWP1). A half-mirror (HM) is used as HM2.

A quarter waveplate (QWP2) and a linear polarizer (POL) are bonded to a surface on the pupil plane SP side of the glass block CG. A linear polarizer is disposed on a lens surface on the pupil plane SP side of the first lens to reduce reflection of external light by the reflective polarization film.

Table 1 summarizes the values of inequalities (1) to (5) in numerical example 4. The observation optical system according to numerical example 4 satisfies all inequalities (1) to (5).

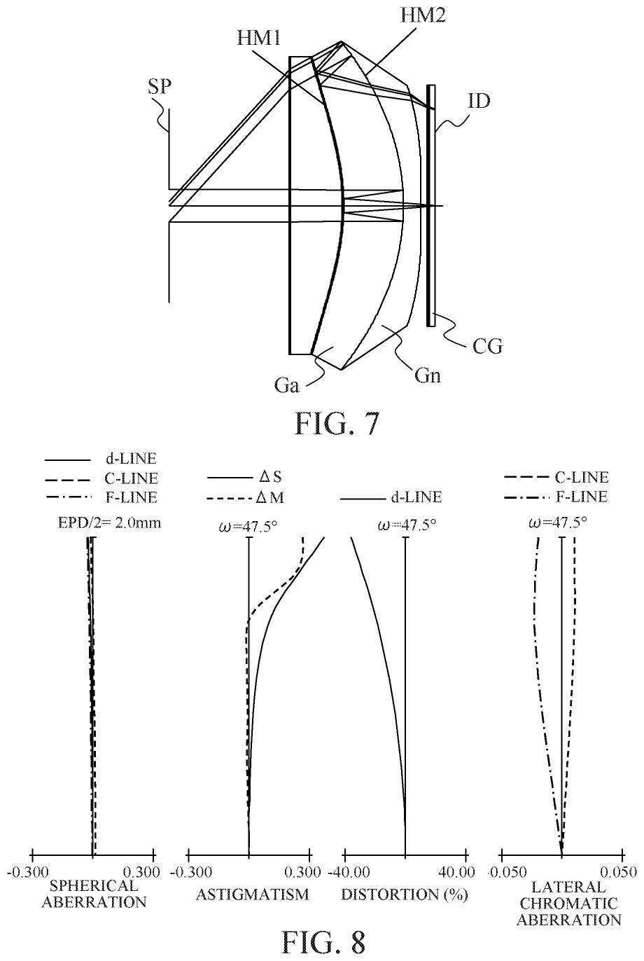

FIG. 8 illustrates longitudinal aberrations of the optical system according to numerical example 4.

### Example 5

The optical system according to Example 5 (numerical example 5) illustrated in FIG. 9 is an optical system having an overall angle of field of about 100°. The basic configuration of the optical system according to Example 5 is the same as that according to Example 4. However, compared with Example 4, the angle of field and lens materials are changed, and the first lens is changed to a biconvex shape.

The polarization utilization configuration and the optical path of image light guided from the display surface ID to the pupil plane SP are the same as those according to Example 4. However, in this example, the linear polarizer disposed on the lens surface on the pupil plane SP side of the first lens in Example 4 is laminated with the reflective polarization film (PBS) and disposed on the cemented surface between the first lens and the second lens.

Table 1 summarizes the values of inequalities (1) to (5) in numerical example 5. The observation optical system according to numerical example 5 satisfies all inequalities (1) to (5).

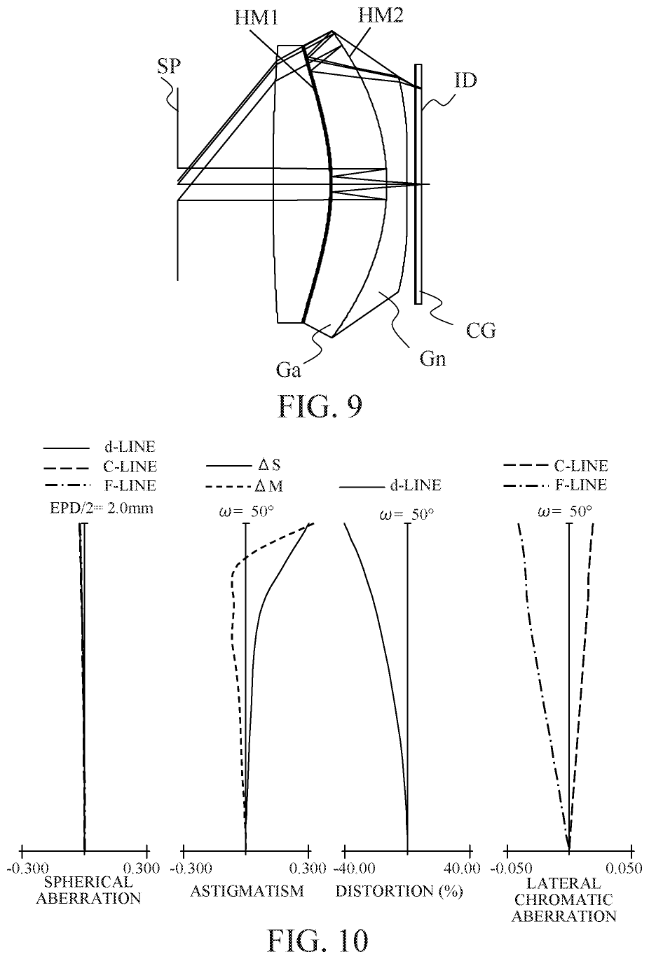

FIG. 10 illustrates longitudinal aberrations of the optical system according to numerical example 5.

### Example 6

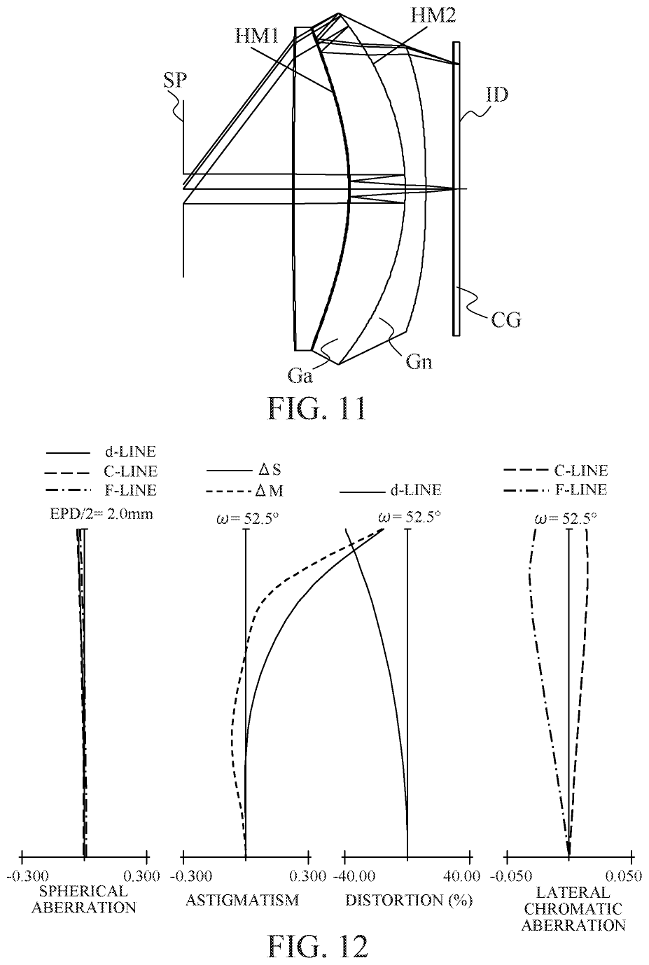

The optical system according to Example 6 (numerical example 6) illustrated in FIG. 11 is an optical system having an overall angle of field of about 105°. The basic configuration of the optical system according to Example 6 is the same as that according to Example 4. However, compared with Example 4, the display element is increased in size, the first lens is changed to a biconvex shape, and the third lens is changed to a meniscus shape having a convex surface facing the display surface ID side.

The polarization utilization configuration and the optical path of image light guided from the display surface ID to the pupil plane SP are the same as those according to Example 4.

Table 1 summarizes the values of inequalities (1) to (5) in numerical example 6. The observation optical system according to numerical example 6 satisfies all inequalities (1) to (5).

FIG. 12 illustrates longitudinal aberrations of the optical system according to numerical example 6.

Although polarization utilization configuration 1 is employed in Examples 1 to 6 described above, the polarization utilization configuration 2 may also be employed.

Numerical examples 1 to 6 will be illustrated below. In each numerical example, a surface number i indicates the order of the surface counted from the object side. r represents a radius of curvature (mm) of an i-th surface counted from the object side, d represents a lens thickness or air gap (mm) on the optical axis between i-th and (i+1)-th surfaces, and nd represents a refractive index for the d-line of an optical material between i-th and (i+1)-th surfaces. vd represents an Abbe number of the optical material between i-th and (i+1)-th surfaces based on the d-line.

The Abbe number vd based on the d-line is expressed as:

$$v d = ( N d - 1 ) / ( N F - N C )$$

where Nd, NF, and NC represent refractive indices for the d-line (587.6 nm), F-line (486.1 nm), and C-line (656.3 nm) in the Fraunhofer line, respectively.

The effective diameter represents a diameter (mm) of a region of the i-th lens surface through which rays contributing to imaging pass.

EPD represents a pupil diameter (mm). BF represents a back focus (mm). The back focus represents a distance on the optical axis from a surface on the display surface ID side (final surface) of the optical system to the display surface ID (described as an image plane in the numerical examples), expressed as an air-equivalent length. An overall lens length represents a length obtained by adding the back focus to a distance on the optical axis from a surface on the pupil plane SP side (frontmost surface) of the optical system to the final surface.

An asterisk “*” attached to a surface number indicates that the surface has an aspherical shape. The aspherical shape is expressed by the following equation:

$$X = \frac{{H}^{2} / r}{1 + \sqrt{1 - ( 1 + K ) {( H / r )}^{2}}} + A 4 \cdot {H}^{4} + A 6 \cdot {H}^{6} + A 8 \cdot {H}^{8} + A 10 \cdot {H}^{10}$$

where X represents a displacement amount from a surface vertex in the optical axis direction, H represents a height from the optical axis in a direction orthogonal to the optical axis, a light traveling direction is positive, r represents a paraxial radius of curvature, K represents a conic constant, and A4, A6, A8, and A10 represent aspherical coefficients.

In the conic constant and the aspherical coefficients, “e±x” represents ×10^{±x}.

### Numerical Example 1

UNIT: mm
SURFACE DATA

| | | | | | Effective | |
|---|---|---|---|---|---|---|
| Surface No. | r | d | nd | νd | Diameter | |
| 1 (Pupil Plane) | ∞ | (Variable) | | | 4.00 | |
| 2* | 94.986 | 0.20 | 1.48000 | 50.0 | 36.00 | |
| 3* | 94.986 | 5.50 | 1.49171 | 57.4 | 36.00 | |
| 4* | −71.282 | 0.10 | 1.58000 | 30.0 | 36.00 | |
| 5* | −71.282 | 1.80 | 1.58306 | 30.2 | 36.00 | HM1 |
| 6 | ∞ | 0.10 | 1.58000 | 30.0 | 39.50 | |
| 7 | ∞ | 8.00 | 1.54390 | 56.0 | 39.50 | |
| 8* | −39.963 | −8.00 | Reflective | | 41.60 | HM2 |
| | | | Surface | | | |
| 9 | ∞ | −0.10 | 1.58000 | 30.0 | 39.50 | |
| 10 | ∞ | −1.80 | 1.58306 | 30.2 | 39.50 | |
| 11* | −71.282 | 1.80 | Reflective | | 36.00 | HM1 |
| | | | Surface | | | |
| 12 | ∞ | 0.10 | 1.58000 | 30.0 | 39.50 | |
| 13 | ∞ | 8.00 | 1.54390 | 56.0 | 39.50 | |
| 14* | −39.963 | 0.77 | | | 41.60 | HM2 |
| 15 | ∞ | 0.10 | 1.58000 | 30.0 | 30.00 | |
| 16 | ∞ | 0.10 | 1.48000 | 50.0 | 30.00 | |
| 17 | ∞ | 0.70 | 1.51633 | 64.1 | 30.00 | |
| 18 | ∞ | 0.00 | | | 30.00 | |
| Image Plane | ∞ | | | | | |

ASPHERIC DATA
2nd Surface
K = 0.00000e+00 A 4 = −4.87128e−06 A 6 = 1.72268e−08
A 8 = −3.73426e−11
3rd Surface
K = 0.00000e+00 A 4 = −4.87128e−06 A 6 = 1.72268e−08
A 8 = −3.73426e−11
4th Surface
K = 0.00000e+00 A 4 = 8.50581e−07 A 6 = 2.41342e−09
A 8 = 2.07690e−12
5th Surface
K = 0.00000e+00 A 4 = 8.50581e−07 A 6 = 2.41342e−09
A 8 = 2.07690e−12
8th Surface
K = 0.00000e+00 A 4 = −2.89351e−07 A 6 = 2.17156e−09
A 8 = −3.28232e−12
A10 = 5.62384e−15
11th Surface
K = 0.00000e+00 A 4 = 8.50581e−07 A 6 = 2.41342e−09
A 8 = 2.07690e−12
14th Surface
K = 0.00000e+00 A 4 = −2.89351e−07 A 6 = 2.17156e−09
A 8 = −3.28232e−12 A10 = 5.62384e−15

VARIOUS DATA

| | |
|---|---|
| Focal Length | 17.07 |
| EPD | 4.00 |
| Half Angle of Field (°) | 50.00 |
| Overall Lens Length | 17.37 (in G) |
| BF | 1.37 (in Air) |
| d1 | 15.00 |

SINGLE LENS DATA

| Lens | Starting Surface | Focal Length |
|---|---|---|
| 1 | 3 | 83.73 |
| 2 (Gn) | 5 | −122.25 |
| 3 (Ga | 7 | 73.48 |
| 4 (CG) | 17 | 0.00 |

### Numerical Example 2

UNIT: mm
SURFACE DATA

| Surface | | | | | Effective | |
|---|---|---|---|---|---|---|
| No. | r | d | nd | νd | Diameter | |
| 1 (Pupil | ∞ | (Variable) | | | 7.39 | |
| Plane) | | | | | | |
| 2* | 256.852 | 0.20 | 1.48000 | 50.0 | 39.00 | |
| 3* | 256.852 | 6.80 | 1.53500 | 56.0 | 39.00 | |
| 4* | −65.567 | 0.10 | 1.58000 | 30.0 | 39.00 | |
| 5* | −65.567 | 2.75 | 1.63500 | 23.9 | 39.00 | HM1 |
| 6 | −121.543 | 0.10 | 1.58000 | 30.0 | 43.00 | |
| 7 | −121.543 | 8.00 | 1.50000 | 53.0 | 43.00 | |
| 8* | −45.082 | −8.00 | Reflective | | 46.50 | HM2 |
| | | | Surface | | | |
| 9 | −121.543 | −0.10 | 1.58000 | 30.0 | 43.00 | |
| 10 | −121.543 | −2.75 | 1.63500 | 23.9 | 43.00 | |
| 11* | −65.567 | 2.75 | Reflective | | 39.00 | HM1 |
| | | | Surface | | | |
| 12 | −121.543 | 0.10 | 1.58000 | 30.0 | 43.00 | |
| 13 | −121.543 | 8.00 | 1.50000 | 53.0 | 43.00 | |
| 14* | −45.082 | 3.53 | | | 46.50 | HM2 |
| 15 | ∞ | 0.10 | 1.58000 | 30.0 | 40.00 | |
| 16 | ∞ | 0.10 | 1.48000 | 50.0 | 40.00 | |
| 17 | ∞ | 0.70 | 1.51633 | 64.1 | 40.00 | |
| 18 | ∞ | 0.00 | | | 40.00 | |
| Image Plane | ∞ | | | | | |

ASPHERIC DATA
2nd Surface
K = 0.00000e+00 A 4 = −1.22299e−06 A 6 = 5.45602e−09
A 8 = −1.09803e−11
3rd Surface
K = 0.00000e+00 A 4 = −1.22299e−06 A 6 = 5.45602e−09
A 8 = −1.09803e−11
4th Surface
K = 0.00000e+00 A 4 = −1.05644e−06 A 6 = 4.29253e−09
A 8 = −5.02523e−12
5th Surface
K = 0.00000e+00 A 4 = −1.05644e−06 A 6 = 4.29253e−09
A 8 = −5.02523e−12
8th Surface
K = 0.00000e+00 A 4 = −1.35968e−07 A 6 = −4.86800e−11
A 8 = 1.74545e−12 A10 = −2.00638e−15
11th Surface
K = 0.00000e+00 A 4 = −1.05644e−06 A 6 = 4.29253e−09
A 8 = −5.02523e−12
14th Surface
K = 0.00000e+00 A 4 = −1.35968e−07 A 6 = −4.86800e−11
A 8 = 1.74545e−12 A10 = −2.00638e−15

VARIOUS DATA

| | |
|---|---|
| Focal Length | 22.16 |
| EPD | 4.00 |
| Half Angle of Field (°) | 47.50 |
| Overall Lens Length | 22.38 (in G) |
| BF | 4.12 (in Air) |
| d1 | 15.00 |

SINGLE LENS DATA

| Lens | Starting Surface | Focal Length |
|---|---|---|
| 1 | 3 | 98.36 |
| 2 (Gn) | 5 | −228.56 |
| 3 (Ga) | 7 | 138.50 |
| 4 (CG) | 17 | 0.00 |

### Numerical Example 3

UNIT: mm
SURFACE DATA

| | | | | | Effective | |
|---|---|---|---|---|---|---|
| Surface No. | r | d | nd | νd | Diameter | |
| 1 (Pupil Plane) | ∞ | (Variable) | | | 7.29 | |
| 2* | 384.803 | 7.50 | 1.64220 | 22.4 | 41.40 | |
| 3* | −61.478 | 0.10 | 1.48000 | 50.0 | 41.40 | |
| 4* | −61.478 | 0.10 | 1.58000 | 30.0 | 41.40 | |
| 5* | −61.478 | 1.80 | 1.64220 | 22.4 | 41.40 | HM1 |
| 6 | ∞ | 0.10 | 1.58000 | 30.0 | 46.50 | |
| 7 | ∞ | 9.85 | 1.54390 | 56.0 | 46.50 | |
| 8* | −43.478 | −9.85 | Reflective | | 49.20 | HM2 |
| | | | Surface | | | |
| 9 | ∞ | −0.10 | 1.58000 | 30.0 | 46.50 | |
| 10 | ∞ | −1.80 | 1.64220 | 22.4 | 46.50 | |
| 11* | −61.478 | 1.80 | Reflective | | 41.40 | HM1 |
| | | | Surface | | | |
| 12 | ∞ | 0.10 | 1.58000 | 30.0 | 46.50 | |
| 13 | ∞ | 9.85 | 1.54390 | 56.0 | 46.50 | |
| 14* | −43.478 | 0.80 | | | 49.20 | HM2 |
| 15 | ∞ | 0.10 | 1.58000 | 30.0 | 40.00 | |
| 16 | ∞ | 0.10 | 1.48000 | 50.0 | 40.00 | |
| 17 | ∞ | 0.70 | 1.51633 | 64.1 | 40.00 | |
| 18 | ∞ | 0.00 | | | 40.00 | |
| Image Plane | ∞ | | | | | |

ASPHERIC DATA
2nd Surface
K = 0.00000e+00 A 4 = 9.51944e−07 A 6 = 3.19792e−09
A 8 = −4.88232e−12
3rd Surface
K = 0.00000e+00 A 4 = 2.94638e−06 A 6 = −8.41332e−10
A 8 = −1.89185e−13
4th Surface
K = 0.00000e+00 A 4 = 2.94638e−06 A 6 = −8.41332e−10
A 8 = −1.89185e−13
5th Surface
K = 0.00000e+00 A 4 = 2.94638e−06 A 6 = −8.41332e−10
A 8 = −1.89185e−13
8th Surface
K = 0.00000e+00 A 4 = 3.12976e−07 A 6 = 3.91888e−10
A 8 = 4.45492e−13 A10 = 2.13999e−16
11th Surface
K = 0.00000e+00 A 4 = 2.94638e−06 A 6 = −8.41332e−10
A 8 = −1.89185e−13
14th Surface
K = 0.00000e+00 A 4 = 3.12976e−07 A 6 = 3.91888e−10
A 8 = 4.45492e−13 A10 = 2.13999e−16

VARIOUS DATA

| | |
|---|---|
| Focal Length | 20.56 |
| EPD | 4.00 |
| Half Angle of Field (°) | 55.00 |
| Overall Lens Length | 21.15 (in G) |
| BF | 1.39 (in Air) |
| d1 | 12.00 |

SINGLE LENS DATA

| Lens | Starting Surface | Focal Length |
|---|---|---|
| 1 | 1 | 83.09 |
| 2 (Gn) | 5 | −95.73 |
| 3 (Ga) | 7 | 79.94 |
| 4 (CG) | 17 | 0.00 |

### Numerical Example 4

UNIT: mm
SURFACE DATA

| | | | | | Effective | |
|---|---|---|---|---|---|---|
| Surface No. | r | d | nd | νd | Diameter | |
| 1 (Pupil Plane) | ∞ | (Variable) | | | 7.08 | |
| 2 | ∞ | 0.20 | 1.48000 | 50.0 | 37.00 | |
| 3 | ∞ | 6.50 | 1.54390 | 56.0 | 37.00 | |
| 4* | −28.195 | 0.10 | 1.58000 | 30.0 | 37.00 | |
| 5* | −28.195 | 0.10 | 1.58000 | 30.0 | 37.00 | HM1 |
| 6* | −28.195 | 7.48 | 1.54390 | 56.0 | 37.00 | |
| 7* | −28.195 | −7.48 | Reflective | | 41.00 | HM2 |
| | | | Surface | | | |
| 8* | −28.195 | −0.10 | 1.58000 | 30.0 | 37.00 | |
| 9* | −28.195 | 0.10 | Reflective | | 37.00 | HM1 |
| | | | Surface | | | |
| 10* | −28.195 | 7.48 | 1.54390 | 56.0 | 37.00 | |
| 11* | −28.195 | 2.22 | 1.64220 | 22.4 | 41.00 | HM2 |
| 12* | 270.534 | 0.80 | | | 29.80 | |
| 13 | ∞ | 0.10 | 1.58000 | 30.0 | 30.00 | |
| 14 | ∞ | 0.10 | 1.48000 | 50.0 | 30.00 | |
| 15 | ∞ | 0.70 | 1.51633 | 64.1 | 30.00 | |
| 16 | ∞ | 0.00 | | | 30.00 | |
| Image Plane | ∞ | | | | | |

ASPHERIC DATA
4th Surface
K = 0.00000e+00 A 4 = 3.18176e−05 A 6 = −2.54232e−08
A 8 = 1.73818e−11
5th Surface
K = 0.00000e+00 A 4 = 3.18176e−05 A 6 = −2.54232e−08
A 8 = 1.73818e−11
6th Surface
K = 0.00000e+00 A 4 = 3.18176e−05 A 6 = −2.54232e−08
A 8 = 1.73818e−11
7th Surface
K = 0.00000e+00 A 4 = 2.78325e−06 A 6 = 4.17527e−09
A 8 = 3.96250e−13 A10 = 1.29453e−14
8th Surface
K = 0.00000e+00 A 4 = 3.18176e−05 A 6 = −2.54232e−08
A 8 = 1.73818e−11
9th Surface
K = 0.00000e+00 A 4 = 3.18176e−05 A 6 = −2.54232e−08
A 8 = 1.73818e−11
10th Surface
K = 0.00000e+00 A 4 = 3.18176e−05 A 6 = −2.54232e−08
A 8 = 1.73818e−11
11th Surface
K = 0.00000e+00 A 4 = 2.78325e−06 A 6 = 4.17527e−09
A 8 = 3.96250e−13 A10 = 1.29453e−14
12th Surface
K = 0.00000e+00 A 4 = −1.33350e−04 A 6 = 8.94427e−07
A 8 = −3.14443e−09 A10 = 4.25092e−12

VARIOUS DATA

| | |
|---|---|
| Focal Length | 17.22 |
| EPD | 4.00 |
| Half Angle of Field (°) | 47.50 |
| Overall Lens Length | 18.30 (in G) |
| BF | 1.40 (in Air) |
| d1 | 15.00 |

SINGLE LENS DATA

| Lens | Starting Surface | Focal Length |
|---|---|---|
| 1 | 3 | 51.84 |
| 2 (Ga) | 6 | 554.37 |
| 3 (Gn) | 11 | −39.65 |
| 4 (CG) | 15 | 0.00 |

### Numerical Example 5

UNIT: mm
SURFACE DATA

| | | | | | Effective | |
|---|---|---|---|---|---|---|
| Surface No. | r | d | nd | νd | Diameter | |
| 1 (Pupil Plane) | ∞ (Variable) | | | | 7.05 | |
| 2 | 248.102 | 7.20 | 1.54390 | 56.0 | 34.80 | |
| 3* | −29.288 | 0.10 | 1.48000 | 50.0 | 34.80 | |
| 4* | −29.288 | 0.10 | 1.58000 | 30.0 | 34.80 | |
| 5* | −29.288 | 0.10 | 1.58000 | 30.0 | 34.80 | HM1 |
| 6* | −29.288 | 6.90 | 1.54390 | 56.0 | 34.80 | |
| 7* | −27.824 | −6.90 | Reflective | | 38.50 | HM2 |
| | | | Surface | | | |
| 8* | −29.288 | −0.10 | 1.58000 | 30.0 | 34.80 | |
| 9* | −29.288 | 0.10 | Reflective | | 34.80 | HM1 |
| | | | Surface | | | |
| 10* | −29.288 | 6.90 | 1.54390 | 56.0 | 34.80 | |
| 11* | −27.824 | 2.50 | 1.58306 | 30.2 | 38.50 | HM2 |
| 12* | 58.424 | 0.99 | | | 27.00 | |
| 13 | ∞ | 0.10 | 1.58000 | 30.0 | 30.00 | |
| 14 | ∞ | 0.10 | 1.48000 | 50.0 | 30.00 | |
| 15 | ∞ | 0.70 | 1.51633 | 64.1 | 30.00 | |
| 16 | ∞ | 0.00 | | | 30.00 | |
| Image Plane | ∞ | | | | | |

ASPHERIC DATA
3rd Surface
K = 0.00000e+00 A 4 = 2.73479e−05 A 6 = −1.30936e−08
A 8 = 3.65649e−12
4th Surface
K = 0.00000e+00 A 4 = 2.73479e−05 A 6 = −1.30936e−08
A 8 = 3.65649e−12
5th Surface
K = 0.00000e+00 A 4 = 2.73479e−05 A 6 = −1.30936e−08
A 8 = 3.65649e−12
6th Surface
K = 0.00000e+00 A 4 = 2.73479e−05 A 6 = −1.30936e−08
A 8 = 3.65649e−12
7th Surface
K = 0.00000e+00 A 4 = 3.02459e−06 A 6 = 4.30603e−09
A 8 = 2.51882e−12 A10 = 1.52296e−14
8th Surface
K = 0.00000e+00 A 4 = 2.73479e−05 A 6 = −1.30936e−08
A 8 = 3.65649e−12
9th Surface
K = 0.00000e+00 A 4 = 2.73479e−05 A 6 = −1.30936e−08
A 8 = 3.65649e−12
10th Surface
K = 0.00000e+00 A 4 = 2.73479e−05 A 6 = −1.30936e−08
A 8 = 3.65649e−12
11th Surface
K = 0.00000e+00 A 4 = 3.02459e−06 A 6 = 4.30603e−09
A 8 = 2.51882e−12 A10 = 1.52296e−14
12th Surface
K = 0.00000e+00 A 4 = −3.09815e−04 A 6 = 2.95945e−06
A 8 = −1.35266e−08 A10 = 2.30855e−11

VARIOUS DATA

| | |
|---|---|
| Focal Length | 16.87 |
| EPD | 4.00 |
| Half Angle of Field (°) | 50.00 |
| Overall Lens Length | 18.79 (in G) |
| BF | 1.58 (in Air) |
| d1 | 12.00 |

SINGLE LENS DATA

| Lens | Starting Surface | Focal Length |
|---|---|---|
| 1 | 1 | 48.61 |
| 2 (Ga) | 6 | 384.65 |
| 3 (Gn) | 11 | −31.98 |
| 4 (CG) | 15 | 0.00 |

### Numerical Example 6

UNIT: mm
SURFACE DATA

| Surface | | | | | Effective | |
|---|---|---|---|---|---|---|
| No. | r | d | nd | νd | Diameter | |
| 1 (Pupil | ∞ | (Variable) | | | 7.36 | |
| Plane) | | | | | | |
| 2 | 872.526 | 0.20 | 1.48000 | 50.0 | 44.00 | |
| 3 | 872.526 | 7.50 | 1.54390 | 56.0 | 44.00 | |
| 4* | −37.862 | 0.10 | 1.58000 | 30.0 | 44.00 | |
| 5* | −37.862 | 0.10 | 1.58000 | 30.0 | 44.00 | HM1 |
| 6* | −37.862 | 7.60 | 1.49171 | 57.4 | 44.00 | |
| 7* | −34.077 | −7.60 | Reflective | | 48.00 | HM2 |
| | | | Surface | | | |
| 8* | −37.862 | −0.10 | 1.58000 | 30.0 | 44.00 | |
| 9* | −37.862 | 0.10 | Reflective | | 44.00 | HM1 |
| | | | Surface | | | |
| 10* | −37.862 | 7.60 | 1.49171 | 57.4 | 44.00 | |
| 11* | −34.077 | 2.80 | 1.66100 | 20.4 | 48.00 | HM2 |
| 12* | −196.909 | 3.72 | | | 39.00 | |
| 13 | ∞ | 0.10 | 1.58000 | 30.0 | 40.00 | |
| 14 | ∞ | 0.10 | 1.48000 | 50.0 | 40.00 | |
| 15 | ∞ | 0.70 | 1.51633 | 64.1 | 40.00 | |
| 16 | ∞ | 0.00 | | | 40.00 | |
| Image Plane | ∞ | | | | | |

ASPHERIC DATA
4th Surface
K = 0.00000e+00 A 4 = 7.78987e−06
5th Surface
K = 0.00000e+00 A 4 = 7.78987e−06
6th Surface
K = 0.00000e+00 A 4 = 7.78987e−06
7th Surface
K = 0.00000e+00 A 4 = 8.59302e−07 A 6 = 1.79369e−09
A 8 = −1.62389e−12 A10 = 3.74479e−15
8th Surface
K = 0.00000e+00 A 4 = 7.78987e−06
9th Surface
K = 0.00000e+00 A 4 = 7.78987e−06
10th Surface
K = 0.00000e+00 A 4 = 7.78987e−06
11th Surface
K = 0.00000e+00 A 4 = 8.59302e−07 A 6 = 1.79369e−09
A 8 = −1.62389e−12 A10 = 3.74479e−15
12th Surface
K = 0.00000e+00 A 4 = −2.34199e−05 A 6 = 4.84486e−08
A 8 = −6.30264e−11 A10 = 3.54562e−14

VARIOUS DATA

| | |
|---|---|
| Focal Length | 21.81 |
| EPD | 4.00 |
| Half Angle of Field (°) | 52.50 |
| Overall Lens Length | 22.92 (in G) |
| BF | 4.32 (in Air) |
| d1 | 15.00 |

SINGLE LENS DATA

| Lens | Starting Surface | Focal Length |
|---|---|---|
| 1 | 3 | 66.91 |
| 2 (Ga) | 6 | 417.12 |
| 3 (Gn) | 11 | −62.77 |
| 4 (CG) | 15 | 0.00 |

TABLE 1

| | Lower | Upper | Numerical Example | | | | | |
|---|---|---|---|---|---|---|---|---|
| Inequality | Limit | Limit | 1 | 2 | 3 | 4 | 5 | 6 |
| (1) | 10.0 | 50.0 | 30.20 | 23.90 | 22.40 | 22.40 | 30.20 | 20.40 |
| (2) | −10.0 | −1.0 | −7.162 | −10.314 | −4.656 | −2.303 | −1.896 | −2.878 |
| (3) | 0.0 | 1.0 | 0.561 | 0.688 | 0.707 | 1.0 | 0.950 | 0.900 |
| (4) | 40.0 | 90.0 | 56.0 | 53.0 | 56.0 | 56.0 | 56.00 | 57.40 |
| (5) | 1.0 | 100.0 | 4.305 | 6.250 | 3.888 | 32.203 | 22.802 | 19.124 |

### Display Apparatus

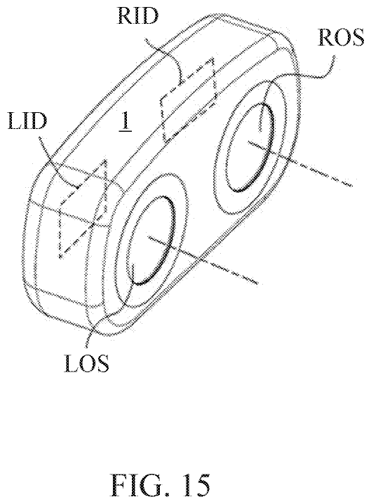

FIG. 15 illustrates a head-mounted display (HMD) as an image display apparatus using the observation optical system according to any one of Examples 1 to 6. The HMD is worn on the observer's head (in front of the eyes) by an attachment mechanism not illustrated.

The HMD includes right-eye and left-eye image display elements RID and LID, respectively, a right-eye observation optical system ROS that guides display light from the right-eye image display element RID to the observer's right eye, and a left-eye observation optical system LOS that guides display light from the left-eye image display element LID to the observer's left eye.

Using the observation optical systems according to Examples 1 to 6 as the right-eye and left-eye observation optical systems ROS and LOS can achieve an HMD that is compact and enables observation of high-quality images with a wide angle of field.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

Each example can provide an optical system having good optical performance.

This application claims the benefit of Japanese Patent Application No. 2025-057713, filed on Mar. 31, 2025, which is hereby incorporated by reference herein in its entirety.

What is claimed is:

1. An optical system that guides image light from a display element toward an observation side, the optical system comprising:
a cemented lens including at least three lenses cemented together that include a negative lens; and
a first transmissive reflective surface and a second transmissive reflective surface, each having a concave shape on the observation side in a paraxial region,
wherein at least one of the first transmissive reflective surface and the second transmissive reflective surface is disposed on a cemented surface of the cemented lens,
wherein the image light is guided toward the observation side via transmission through the second transmissive reflective surface, reflection on the first transmissive reflective surface, reflection on the second transmissive reflective surface, and transmission through the first transmissive reflective surface, and
wherein the following inequalities are satisfied:
$$10. \leq vdGn \leq 50.$$
$$- 10. \leq fGn / f \leq - 1.$$
$$0. < R\_HM2 / R\_HM1 \leq 1.$$
where vdGn is an Abbe number of the negative lens based on d-line, fGn is a focal length of the negative lens in air, f is a focal length of the optical system, R_HM1 is a paraxial radius of curvature of the first transmissive reflective surface, and R_HM2 is a paraxial radius of curvature of the second transmissive reflective surface.

2. The optical system according to claim 1, wherein the negative lens is disposed between the first transmissive reflective surface and the second transmissive reflective surface.

3. The optical system according to claim 2, wherein the negative lens has a plano-concave shape.

4. The optical system according to claim 1, wherein the negative lens is disposed closer to the display element than the second transmissive reflective surface.

5. The optical system according to claim 1, wherein the first transmissive reflective surface is disposed on the cemented surface.

6. The optical system according to claim 1, wherein an intermediate lens is disposed between the first transmissive reflective surface and the second transmissive reflective surface, and
wherein the following inequality is satisfied:
$$40. \leq vdGa \leq 90.$$
where vdGa is an Abbe number of the intermediate lens based on the d-line.

7. The optical system according to claim 1, wherein an intermediate lens is disposed between the first transmissive reflective surface and the second transmissive reflective surface, and
wherein the following inequality is satisfied:
$$1. \leq fGa / f \leq 100.0$$
where fGa is a focal length of the intermediate lens in air.

8. The optical system according to claim 1, wherein one of the first transmissive reflective surface and the second transmissive reflective surface includes a polarization-selective transmissive reflective element.

9. An optical system that guides image light from a display element toward an observation side, the optical system comprising:
a cemented lens including at least three lenses cemented together that include a negative lens; and
a first transmissive reflective surface and a second transmissive reflective surface, each having a concave shape on the observation side in a paraxial region,
wherein at least one of the first transmissive reflective surface and the second transmissive reflective surface is disposed on a cemented surface of the cemented lens, and
wherein the image light is guided toward the observation side via transmission through the second transmissive reflective surface, reflection on the first transmissive reflective surface, reflection on the second transmissive reflective surface, and transmission through the first transmissive reflective surface.

10. A display apparatus comprising:
a display element; and
an optical system that guides image light from the display element toward an observation side,
wherein the optical system includes:
a cemented lens including at least three lenses cemented together that include a negative lens; and
a first transmissive reflective surface and a second transmissive reflective surface, each having a concave shape on the observation side in a paraxial region,
wherein at least one of the first transmissive reflective surface and the second transmissive reflective surface is disposed on a cemented surface of the cemented lens,
wherein the image light is guided toward the observation side via transmission through the second transmissive reflective surface, reflection on the first transmissive reflective surface, reflection on the second transmissive reflective surface, and transmission through the first transmissive reflective surface, and
wherein the following inequalities are satisfied:
$$10. \leq vdGn \leq 50.$$
$$- 10. \leq fGn / f \leq - 1.$$
$$0. < R\_HM2 / R\_HM1 \leq 1.$$
where vdGn is an Abbe number of the negative lens based on d-line, fGn is a focal length of the negative lens in air, f is a focal length of the optical system, R_HM1 is a paraxial radius of curvature of the first transmissive reflective surface, and R_HM2 is a paraxial radius of curvature of the second transmissive reflective surface.
